(19) United States
(12) Patent Application Publication
(10) Pub. No.: US 2022/0263338 A1
(43) Pub. Date: Aug. 18, 2022

(54) Power Backup for LoRa Gateway

(71) Applicant: CROWN CASTLE USA, INC., Canonsburg, PA (US)

(72) Inventors: Alejandro Quinones, San Juan, PR (US); Jose Torres, San Juan, PR (US); Marco Torres, San Juan, PR (US); Jose Santos, San Juan, PR (US)

(21) Appl. No.: 17/671,419

(22) Filed: Feb. 14, 2022

Related U.S. Application Data
(60) Provisional application No. 63/148,809, filed on Feb. 12, 2021.

(51) Int. Cl. H02J 9/06; H02J 7/00; H02J 3/38

(52) U.S. Cl. CPC H02J 9/06; H02J 2300/22; H02J 3/381; H02J 7/0013

(57) ABSTRACT

A power unit powers a Long Range (LoRa) gateway at a communications facility. The power unit has one or more enclosures configured to install on a ground level of the communications facility. The one or more enclosures hold batteries and control circuitry. The batteries are configured to supply backup power. The control circuitry is connected to grid power, alternative power, and the backup power and powers the LoRa gateway with power-over-ethernet (PoE). The control circuity is configured to transition from the grid power to the backup power to power the LoRa gateway in response to an outage of the grid power. The control circuity can also transition to the alternative power, such as generator power or solar-generated power, to power the LoRa gateway. Finally, the control circuitry can charge the batteries using the grid power (if available) or using the alternative power (e.g., solar-generated power or other).

### CROSS-REFERENCE TO RELATED APPLICATIONS

This application claims the benefit of U.S. Provisional Appl. No. 63/148,809 filed 12 Feb. 2021, which is incorporated herein by reference.

### BACKGROUND OF THE DISCLOSURE

In some locations, the power grid may provide an inconsistent supply of power. Loss of power can be due to storms, failing infrastructure, or a host of other reasons. When the power grid fails for whatever reason, wireless communications can be severely affected. This is especially true for radio frequency communications in remote locations. Such radio frequency communications can be used extensively by network-connected nodes, such as components, sensors, and other devices in an infrastructure.

One form of radio frequency communication commonly used includes the Long Range (LoRa) protocol, which offers a low power wide-area network (LPWAN). The radio frequencies fall in the sub-gigahertz bands and can provide long-range transmission (up to 30 miles) in remote locations while consuming little power. In the LoRa network, nodes have transceivers with LoRa devices, which transmit data to gateways in the network. In turn, the gateways can send the data via another communication link (e.g., Wi-Fi, Ethernet, or Cellular) to a network server.

What is needed is a way to keep such radio frequency communications available for periods when a power grid fails, especially in remote locations.

The subject matter of the present disclosure is directed to overcoming, or at least reducing the effects of, one or more of the problems set forth above.

### BRIEF DESCRIPTION OF THE DRAWINGS

FIG. 1 illustrates an operational layout of a backup power unit of the present disclosure for powering a radio frequency communication gateway.

FIGS. 2A-2B illustrate schematics of elements of the disclosed power unit.

FIG. 3A illustrates an arrangement of first elements of the disclosed power unit housed in a first enclosure.

FIG. 3B illustrates an arrangement of second elements of the disclosed power unit housed in a second enclosure.

FIG. 4 illustrates example installations of the backup power unit in the field.

### DETAILED DESCRIPTION

A power backup unit disclosed herein provides backup power for wireless communications, and particularly provides backup power to a Long Range (LoRa) gateway of a LoRa network. The power backup unit includes one or more enclosures that are installed on a ground level of a communications facility. When power from the available power grid fails, the unit provides a seamless transition from grid power to backup power. In this way, the unit is configured to keep the LoRa gateway powered up and to extend the off-grid run time of the LoRa network for about 100 hours or some other time period. Primary, the power unit includes a battery array to supply backup power. The power unit can also be installed with a solar panel to provide backup power and to provide charging power to the battery array, thus becoming an auto powering off-the-grid unit. The power unit also includes connections for an alternative power generator. The power unit has one or more permutations to switch between grip power, battery power, alternative generator power, and solar power transparently.

In the end, the power unit is designed to automatically switch from any four electrical sources and exhaust all existing energy at hand to extend the off-grid run-time-life from the LoRa network for about 3 to 4 days, assuming no solar panel is installed. In this way when grid power fails, the power backup unit can provide about 100 hours of backup power to a LoRa gateway deployed on tower assets. The power unit also provides a seamless transition to generator power or solar power in the case of an extended outage that is longer than the battery backup capacity. In particular, solar power can provide uninterrupted power as long as at least two hours of sunlight are captured by the solar panel to fully charge the batteries. The batteries in turn can provide another 3 to 4 days of backup power.

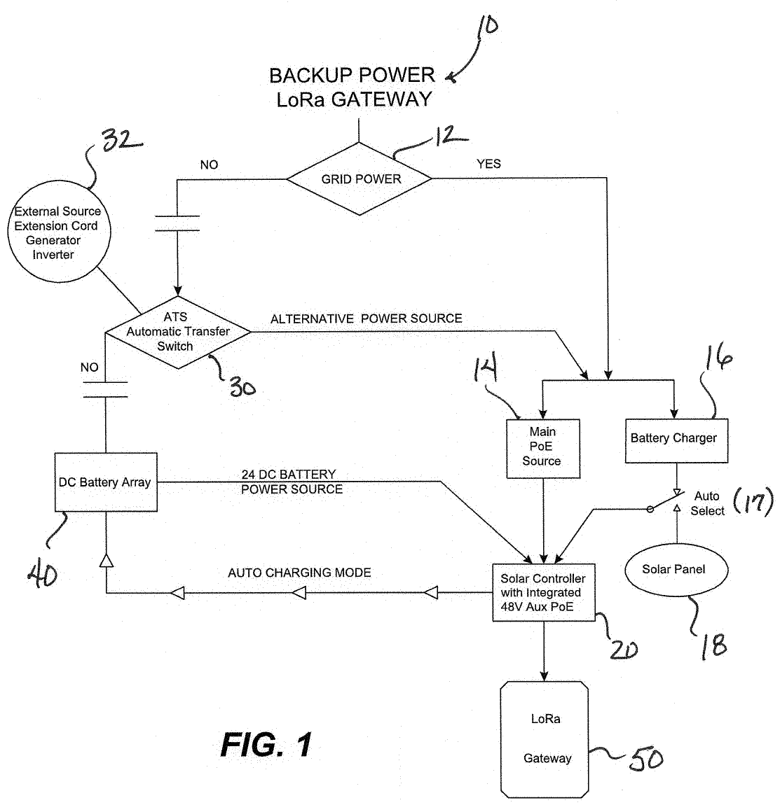

FIG. 1 illustrates an operational layout of a backup power unit 10 of the present disclosure for powering a radio frequency communication gateway 50. Here, the gateway 50 is described as a Long Range (LoRa) gateway, but other lower power communication gateways could also benefit from the disclosed unit 10.

The internal components of the power unit 10 are configured to transition power supply to the LoRa gateway by switching between grid power and an internal battery array. The unit 10 can be further configured to transition with an external energy source, such as a generator, car inverter, temporary power source, etc. The unit can also be configured to transition with a solar panel.

The backup power unit 10 monitors whether conventional grid power is available for powering the gateway 50 (Decision 12). This can be achieved using power monitoring circuitry configured to provide an uninterruptable power supply. If grid power is available, then the disclosed power unit 10 operates to route power to the gateway 50 and to charge backup batteries of the unit 10 as needed. The power from the grid can power a main Power of Ethernet (PoE) source 14 of the unit 10 and can power a battery charger 16. An auto select switch 17 can connect the battery charger 16 or a solar panel 18. Either way, a controller 20 with integrated 48V aux PoE can provide appropriate power to the gateway 50. When in an auto charging mode, the controller 20 can also send charging power to a DC battery array 40 of the power unit 10.

If the power unit 10 monitoring the grid power determines grid power is not available (No at Decision 12), then the unit 10 includes an automatic transfer switch 30 to automatically transfer between other power sources. In particular, the automatic transfer switch 30 can connect to an external power source 32 (generator, inverter, or the like) to provide an alternative power source to the unit's controller 20 and eventually to the gateway 50. The battery charger 16 can also use this alternative power to charge the battery array 40. Should such an external power source not be available, then the automatic transfer switch 30 can have the DC battery array 40 provide power to the unit's controller 20 and the gateway 50. The internal battery array 40 generates the 24V DC power required. Whenever grip power comes available, the unit 10 can then switch back to using the grid power and revert to charging the battery array 40.

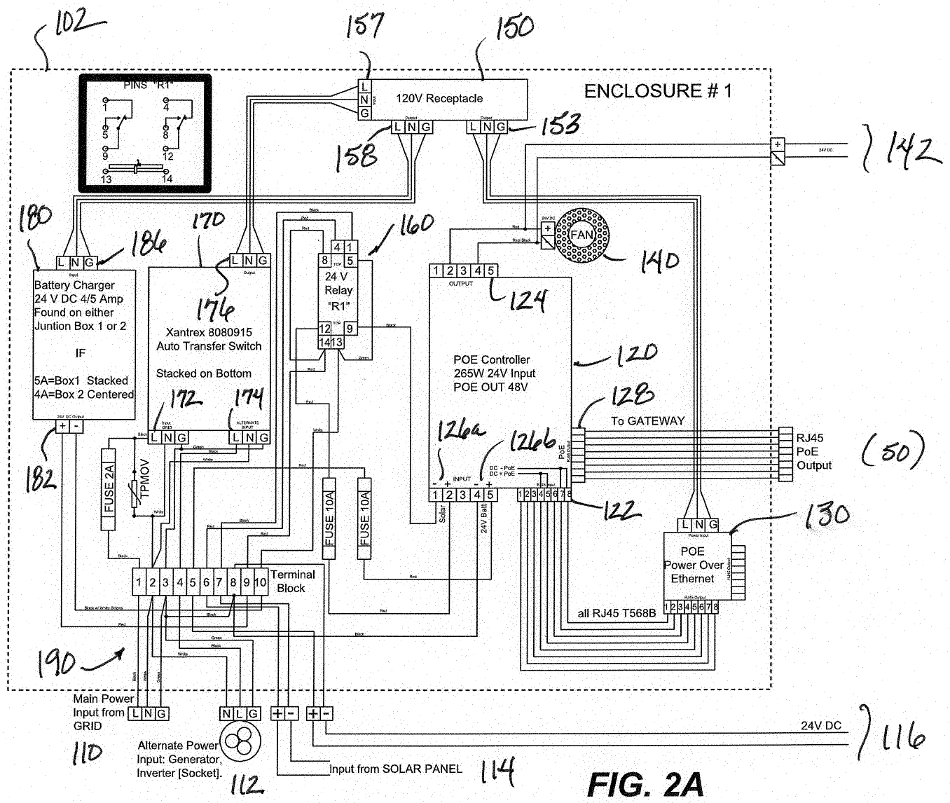

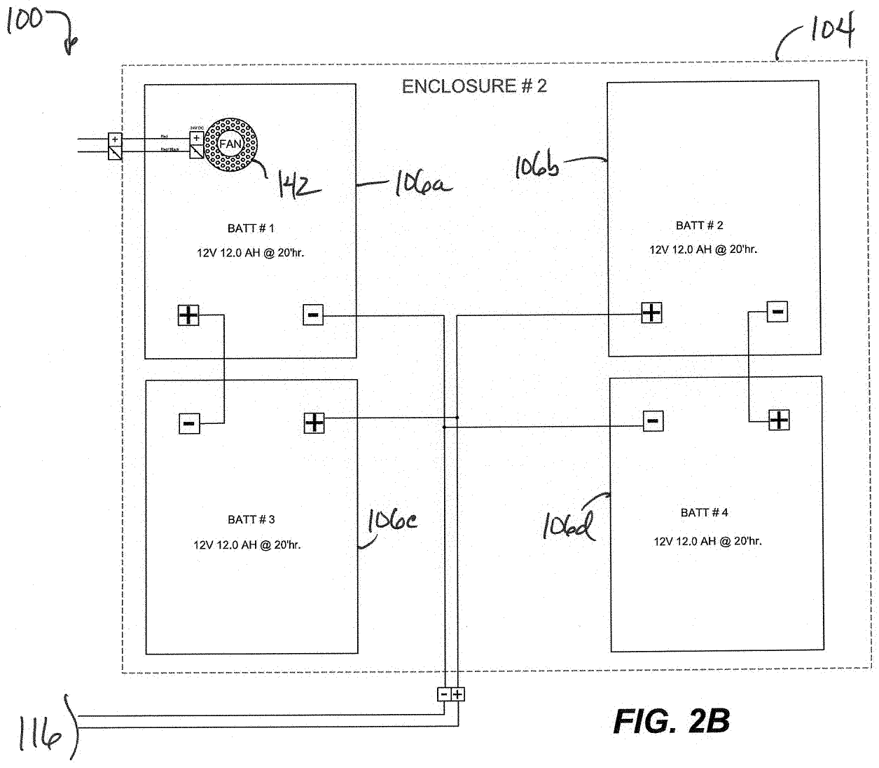

Having an overall understanding of the disclosure power unit 10, the discussion turns to additional details. Looking at FIGS. 2A-2B, schematics show elements of a power unit 100 according to the present disclosure. FIG. 2A illustrates control elements of the power unit 100, and FIG. 2B illustrates battery array elements of the power unit 100. In general, these elements in FIGS. 2A-2B can be combined into one or more enclosures. As depicted here, the control elements in FIG. 2A can be housed in a first enclosure 102, and the battery array elements in FIG. 2B can be housed in a second enclosure 104. Other arrangements are possible.

Looking first at FIG. 2A, the power unit 100 includes a controller 120, a power of ethernet interface 130, a cooling fan 140, a power receptacle 150, a relay 160, an auto transfer switch 170, a battery charger 180, and a terminal block 190.

The terminal block 190 organizes the connections to a main power input 110 from the power grid, an alternative power input 112 from an external power source, an auxiliary input 114 from a solar panel, and a connection 116 for the battery array elements (FIG. 2B).

The controller 120 can be a Power-over-Ethernet (PoE) device having 256W 24V input and 48V PoE output. The controller 120 connects at connector input 122 to power from the PoE device 130, which is coupled to the 120V receptacle 150. The controller 120 provides power output at an output connection 124 to the fans 140, 142. The controller 120 connects at first input connection 126a to the solar power input (114) from the relay 160 and connects at a second input connection 126b to the battery power input (116) from the terminal block 190. The controller 120 includes an output 128 to the gateway 50 to provide PoE output over an appropriate cable.

The auto-transfer switch 170 connects at a first power connection 172 to the main power input 110 and connects at second power connection 174 to the alternative power input 112 through the terminal 190. The transfer switch 170 provides power to output 176 to an input 157 of the receptacle 150, which feeds the controller 120 and the battery charger 180 through outlets 153, 158. For its part, the battery charger 180 includes a power input 186 and provides 24V DC output 182 that connects through the battery array connection 116 to the battery array elements (FIG. 2B).

Looking now at FIG. 2B, the connection 116 for the battery array connects to the terminals of two series of 12V batteries 106a-c connected in parallel. The batteries 106a-c provide 24V power. Power from the controller (120) powers another cooling fan 142.

As shown, the control components in FIG. 2A can be housing one enclosure 102, while the battery array elements in FIG. 2B can be housed in another enclosure 104 of the unit 100. Accordingly, the backup power unit 100 can include one or more non-metallic enclosures 102, 104 that can be mounted on the ground level of a communications facility with the main purpose of providing extended backup power to a radio frequency gateway. Preferably, the enclosures 102, 104 can be made of insulated polyvinyl chloride (PVC) material to make them weather resistant with protection from the corrosion, high temperatures, and the like. The insulated PVC material can be painted white to further bounce away sun rays and to keep the enclosure temperatures from overheating. The PVC material can further protect internal electronic components. Each enclosure 102, 104 can have one or more ventilation ports with fans 140, 142 to dissipate heat and protect the internal components from humidity.

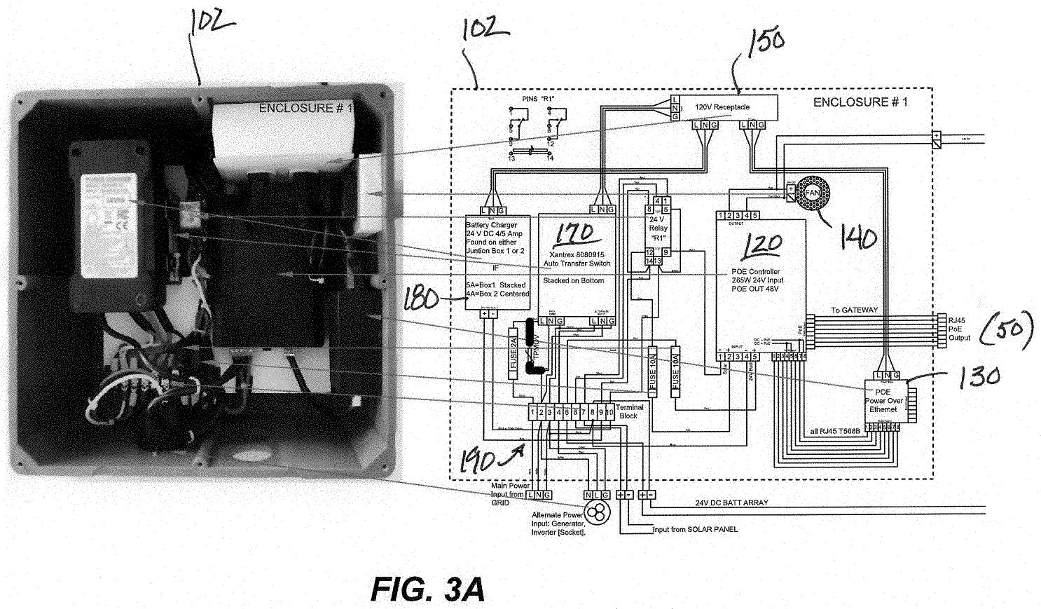

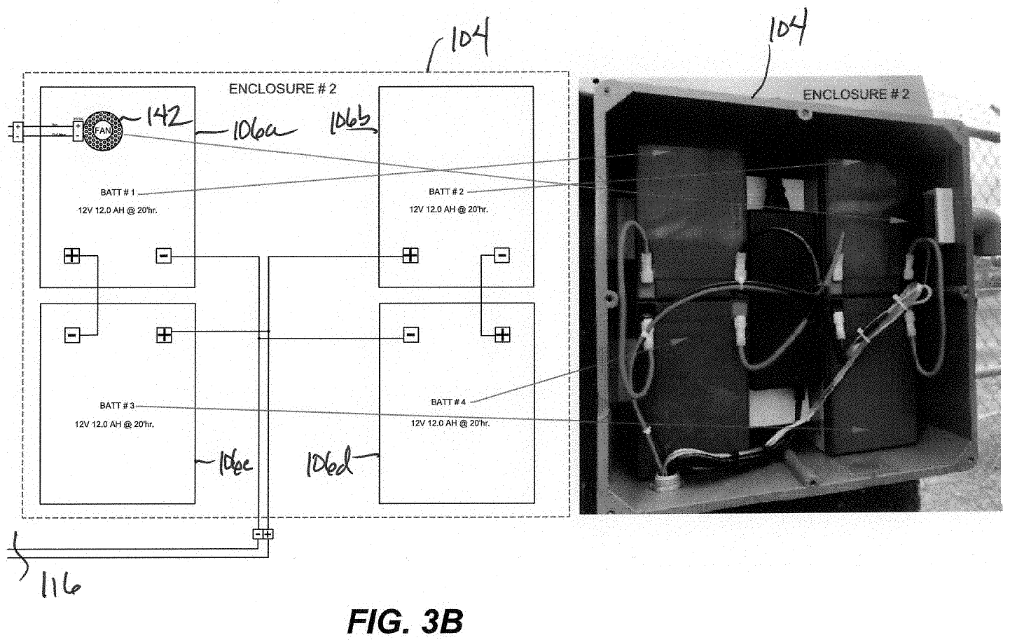

FIG. 3A illustrates an arrangement of first elements of the disclosed power unit 100 housed in a first enclosure 102. These first elements include the control elements (120, 130 . . . 190) described previously. Preferably, entry and exits for the inputs and outputs are disposed on the bottom of the enclosure 102. The fan 140 is preferably mounted on the side of the enclosure 102. The outlet for the fan 140 preferably has a cover, an elbow, a mesh, a vent, or the like to prevent water and debris from entering.

FIG. 3B illustrates an arrangement of second elements of the disclosed power unit 10 housed in a second enclosure 104. These second elements include the battery 1elements (106a-c, fan 142) described previously. Preferably, entry and exits for the inputs and outputs are disposed on the bottom of the enclosure 104. The fan 142 is preferably mounted on the side of the enclosure 104, with the outlet having a cover, an elbow, a vent, or the like to prevent water and debris from entering.

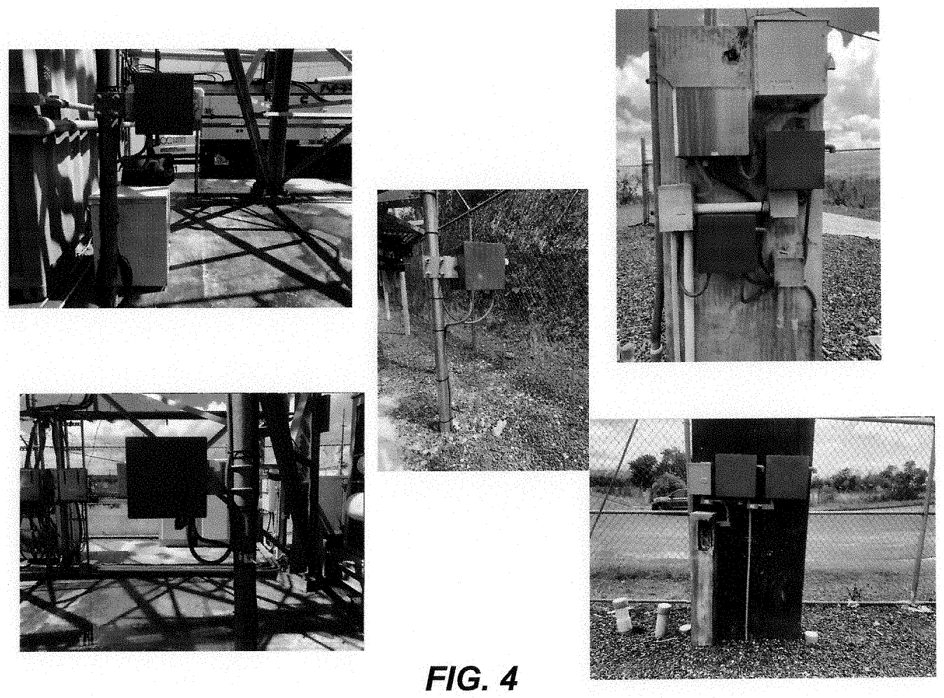

FIG. 4 illustrates example installations of the backup power unit 100. The enclosures 102, 104 can be mounted back-to-back or side-by-side as necessary and can be mounted on panels, columns, poles, or other installation components associated with a wireless antenna, tower, etc. The size of each of the enclosures 102, 104 can be about 1 ft.×1 ft.×6 inches. These twin enclosures 102, 104 are either mounted back-to-back on a galvanized plate, or they are wall-mounted inside a shelter or on an outside wall if needed.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

What is claimed is:

1. A power unit for powering a Long Range (LoRa) gateway at a communications facility, the power unit comprising:
one or more enclosures being configured to install on a ground level of the communications facility;
one or more batteries disposed in the one or more enclosures and being configured to supply backup power; and
control circuitry disposed in the one or more enclosures and connected to grid power, alternative power, and the backup power, the control circuity being configured transition from the grid power to the backup power to power the LoRa gateway in response to an outage of the grid power.

2. The power unit of claim 1, further comprising a solar panel being configured to supply solar-generated power as the alternative power.

3. The power unit of claim 2, wherein the control circuitry is configured to transition to the solar-generated power to power the LoRa gateway.

4. The power unit of claim 2, wherein the control circuitry is configured to charge the one or more batteries with the solar-generated power.

5. The power unit of claim 4, wherein the control circuitry is configured to switch automatically between the grid power and the solar-generated power to charge the one or more batteries.

6. The power unit of claim 1, wherein the control circuitry is configured to transition seamlessly from the backup power to one of generator power or solar-generated power as the alternative power in response to an extended outage of the grid power longer than a capacity of the backup power.

7. An apparatus for powering a Long Range (LoRa) gateway at a communications facility, the apparatus comprising:
one or more enclosures being configured to install at a ground level of the communications facility;
one or more batteries disposed in the one or more enclosure and being configured to supply backup power; and
control circuitry disposed in the one or more enclosures and being configured to power the LoRa gateway, the control circuitry having a first connection to grid power, a second connection to alternative power, and a third connection to the backup power, the control circuity being configured to switch automatically between grid power, the alternative power, and the backup power to power the LoRa gateway.

8. The apparatus of claim 7, wherein the control circuitry is configured to transition seamlessly from the grid power to the alternative power and/or the backup power in response to an outage of the grid power.

9. The apparatus of claim 7, wherein the second connection is configured to receive the alternative power generated by one or more of an external power source, a temporary power source, an electric generator, an automobile, and a solar panel.

10. The apparatus of claim 7, further comprising a solar panel connected to the second connection.

11. The apparatus of claim 10, wherein the control circuitry is configured to provide the alternative power from the solar panel to power the LoRa gateway.

12. The apparatus of claim 10, wherein the control circuitry is configured to provide the alternative power from the solar panel to charge the one or more batteries.

13. The apparatus of claim 7, wherein the control circuitry is configured to transition seamlessly from the backup power to the alternative power in response to an extended outage of the grid power longer than a capacity of the backup power from the one or more batteries.

14. The apparatus of claim 7, wherein the one or more batteries comprise an array of batteries.

15. The apparatus of claim 14, wherein the one or more enclosures comprise a first enclosure having the array of the batteries; and a second enclosure having the control circuitry.

16. The apparatus of claim 7, wherein the control circuitry comprises a battery charger being configured to charge the one or more batteries with the grid power and/or the alternative power.

17. The apparatus of claim 7, wherein the control circuitry comprises an automatic transfer switch connected to the grid power from the first connection and connected to the alternative power from the second connection of one of a generator and an automobile inverter, the automatic transfer switch being configured to output internal power.

18. The apparatus of claim 17, wherein the control circuitry comprises a controller connected to the internal power, the controller further connected to the backup power and connected to solar-generated power as the alternative power, the controller being configured to output power-over-ethernet to power the LoRa gateway.

19. The apparatus of claim 18, wherein the control circuitry comprises:
a battery charger connected to the internal power and being configured to charge the one or more batteries; and
a relay connected to an output of the battery charger and connected between the controller and the solar-generated power.

20. The apparatus of claim 7, wherein each of the one or more enclosures comprises a port having a fan.
